(19) United States
(12) Patent Application Publication
(10) Pub. No.: US 2023/0376844 A1
(43) Pub. Date: Nov. 23, 2023

(54) METHODS, SYSTEMS, ARTICLES OF MANUFACTURE AND APPARATUS TO BUILD BLOCKING-BASED BATCHES FOR TRAINING MACHINE LEARNING MODELS

(71) Applicant: Nielsen Consumer LLC, Chicago, IL (US)

(72) Inventors: Mario Almagro, Valdermoro (ES); David Jiménez Cabello, Lupiana (ES); Diego Ortego Hernández, Alcobendas (ES); Emilio Javier Almazan, Alcorcon (ES)

(21) Appl. No.: 18/162,370

(22) Filed: Jan. 31, 2023

Related U.S. Application Data
(60) Provisional application No. 63/343,457, filed on May 18, 2022.

(51) Int. Cl. G06N 20/00

(52) U.S. Cl. CPC G06N 20/00

(57) ABSTRACT

Methods, apparatus, systems, and articles of manufacture are disclosed to improve model training efficiency comprising block circuitry to: generate a first blocking corresponding to first ones of first data samples retrieved from a first data source, the first ones of the first data samples including a first heuristic; and generate a second blocking corresponding to second ones of the first data samples that include a second heuristic; match circuitry to: retrieve a second data sample from a second data source and determine a match of the first blocking or the second blocking; and assign respective ones of the first data samples from the match one of a first designation type or a second designation type; and batch circuitry to: combine the first designation type and the second designation type into a machine learning input batch.

### RELATED APPLICATION

This patent claims the benefit of U.S. Provisional Patent Application No. 63/343,457, which was filed on May 18, 2022. U.S. Provisional Patent Application No. 63/343,457 is hereby incorporated herein by reference in its entirety. Priority to U.S. Provisional Patent Application No. 63/343,457 is hereby claimed.

### FIELD OF THE DISCLOSURE

This disclosure relates generally to artificial intelligence/machine learning models and, more particularly, to methods, systems, articles of manufacture and apparatus to build blocking-based batches for training machine learning models.

### BACKGROUND

In recent years, product matching has become a fundamental step of consumer behavior in commercial transactions. Machine learning models have allowed for the automation of data collection methods, in which the collected data is filtered for matching products.

### BRIEF DESCRIPTION OF THE DRAWINGS

FIG. 1A is a schematic diagram of an example environment to build blocking-based batches structured in accordance with teachings of this disclosure.

FIG. 1B is schematic diagram of another example environment to build blocking-based batches structured in accordance with teachings of this disclosure.

FIG. 2 is a schematic diagram of an example block-batch circuitry of FIG. 1A structured in accordance with the teachings of this disclosure.

FIG. 3 is a flowchart representative of example machine readable instructions and/or example operations that may be executed by example processor circuitry to implement the block-batch circuitry of FIG. 2.

FIG. 4 is a schematic diagram of an example processing platform including processor circuitry structured to execute the example machine readable instructions and/or the example operations of FIG. 3 to implement the block-batch circuitry of FIG. 2.

FIG. 5 is a schematic diagram of an example implementation of the processor circuitry of FIG. 4.

FIG. 6 is a schematic diagram of another example implementation of the processor circuitry of FIG. 4.

FIG. 7 is a schematic diagram of an example software distribution platform (e.g., one or more servers) to distribute software (e.g., software corresponding to the example machine readable instructions of FIG. 3 to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 8 is a table of test result comparing different model training approaches.

FIG. 9 is a table comparing the computational time between different model training approaches.

In general, the same reference numbers will be used throughout the drawing(s) and accompanying written description to refer to the same or like parts. The figures are not to scale.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

In artificial intelligence systems, automated model training for machine learning models is a valuable asset. Commercial transaction websites offer hundreds of millions of products as a result of online retail expansion. Due to the expansion, performing product matching successfully (e.g., finding offers of the same product from a data source(s)), is a valuable task to enable successful and/or otherwise viable marketing strategies in a competitive landscape. Machine learning models provide the ability to filter data collected from online retailers. In some instances, the machine learning models are trained using batches of training samples (e.g., data samples). In some cases, model training may feed machine learning models positive matches of similar sample descriptions and discard similar non-matches. However, this is problematic because the similar non-matches provide a key role in achieving better similarity learning. In the current state of the art, the models are trained using matches from datasets, excluding similar non-matches (e.g., hard negatives). In consequence, the current approach rejects useful information (similar non-matches) which can be used to train the model to distinguish between two very similar samples.

Additionally, computational effort to train and retrain models is tolling due to the amount of computational resources (e.g., graphical processing unit (GPU) resources, central processing unit (CPU) resources, field programmable gate array (FPGA) resources, accelerator resources, etc.) required to build reliable and/or otherwise useful models that meet industry expectations. Examples disclosed herein involve training machine learning models with batches in a manner that discriminates data types (e.g., positive matches, easy negatives, hard negatives, etc.) to accomplish (a) a relatively faster models learning task(s) and (b) a reduction in wasted computational resources to correct and/or otherwise calibrate less accurate models that employ traditional model training techniques. In other words, the examples disclosed here involve improving model training efficiency. As used herein, a batch is a combining (e.g., pooling, compiling, merging, etc.) of a quantity of samples from a dataset. The samples included in the batch may be positive matches (e.g., first designation types) and/or non-matches (e.g., easy negatives, hard negatives, etc.) determined from blockings. Batches are utilized during the training process to more efficiently and/or otherwise more effectively train machine learning models to be able to differentiate between samples. In some instances, the machine learning model may be limited on the quantity of input data consumed at one time (e.g., due to computational limitations in view of relatively large quantities of input data). Thus, it is beneficial to train the models with relatively smaller, however, more informative batches (e.g., subgroups). Moreover, breaking up large quantities of data from a dataset into batches (e.g., subgroups) improves the efficiency because the model is able to train faster. Consequently, examples disclosed herein facilitate energy savings because models are trained while consuming fewer computational resources.

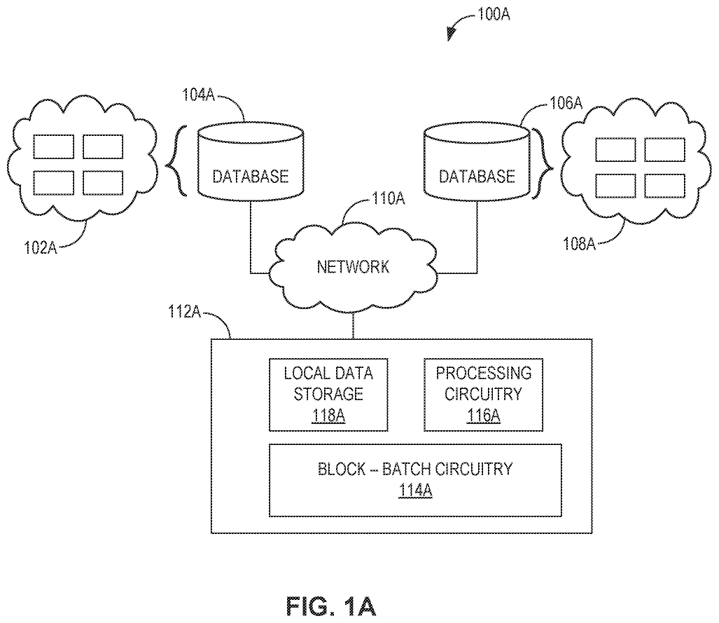

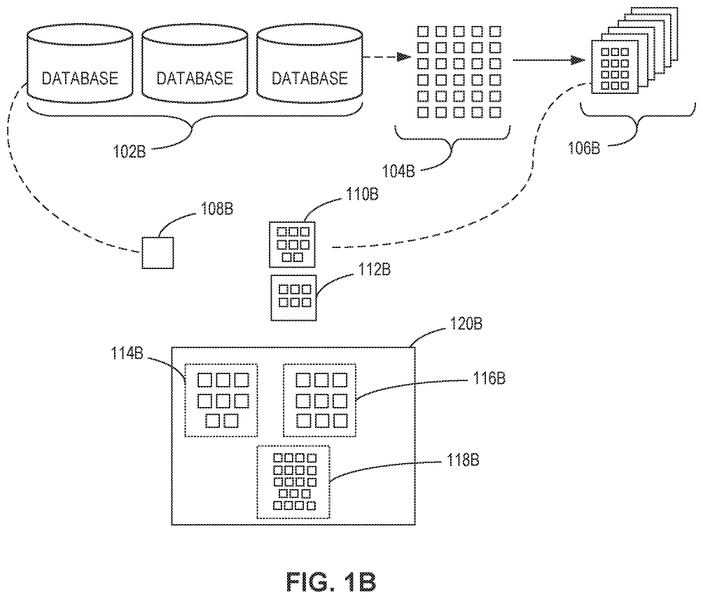

FIG. 1A is a schematic diagram of an example environment to build blocking-based batches structured in accordance with teachings of this disclosure. Blockings, as used herein, represent a dataset of samples sharing a similar heuristic, attribute, and/or characteristic (e.g., brand, color, price, small price difference, date sold, retailer, etc.) to a unique sample (e.g., one specific product). For example, the blocking would be associated with the unique sample and would include all samples within the dataset sharing the same brand, price, and color. Stated differently, examples disclosed herein include one blocking associated with one product such that all samples in a blocking share the same brand or similar price. In some examples, some samples will share a product ID of the product associated with the blocking (e.g., the positive samples). In some examples, the samples not sharing a product ID will be hard negative (e.g., second designation type) samples. As such, samples disclosed herein can be associated with more than one blocking (e.g., being positive in only one and being a hard negative in others). While the term “block” is sometimes used to represent an abstraction of structure or process flow, further uses of the term “block” in that regard will not be used to improve clarity. In the illustrated example of FIG. 1A, the environment to build blocking-based batches 100A (e.g., the “environment”) includes example first data 102A, an example first database 104A, example second data 108A, an example second database 106A, an example network 110A, an example processor platform(s) 112A, example block-batch circuitry 114A, and example processing circuitry 116A.

As described above, the example environment to build blocking-based batches 100A addresses problems related to wasteful computational processing associated with model training. Generally speaking, existing approaches train machine learning models without using fine-grained information that determines two similar samples are not a match. Typical approaches include very different samples (e.g., the samples do not share common heuristics, attributes, and/or characteristic) into the same batch. For example, a sample of a drink and its positive match are grouped together with a sample of a shirt and its positive. Samples of drinks are uninformative non-matches for samples of shirts because they do not share relevant semantic heuristics, attributes, and/or characteristic, (e.g., drinks and shirts are very different and relatively easy to distinguish). Instead, grouping different samples (in addition to the positive ones) based on a brand heuristic that are from the same clothing brand in the same batch (e.g., a shirt and a pant) provides more informative information to distinguish non-matches. Stated differently, typical approaches may exclude two similar samples based on a brand heuristic that are from the same clothing brand, but one sample is a shirt, and the second sample is a pant, thus, a non-match. Typical approaches often include uninformative non-matches: two samples, one a shirt and a second a soft drink, constitute an easy negative (e.g., third designation type) because they do not share relevant semantic heuristics. Thus, typical approaches train machine learning models to differentiate positive samples from very different heuristics rather than two similar samples sharing some heuristics. In some examples, blockings may include example first data 102A and second data 108A stored in the example first database 104A and second database 106A, respectively. In some examples, local data storage 118A is stored on the processor platform(s) 112A. While the illustrated example of FIG. 1A shows the first database 104A and second database 106A, examples disclosed herein are not limited thereto. For instance, any number and/or type of data storage may be implemented that is communicatively connected to any number and/or type of processor platform(s) 112A, either directly and/or via the example network 110A.

As described in further detail below, the example environment to build blocking-based batches 100A (and/or circuitry therein) acquires and/or retrieves labeled and/or described data to build batches from blockings to feed machine learning models for training. The example processor platform(s) 112A instantiates an executable that relies upon and/or otherwise utilizes one or more models in an effort to complete an objective, such as translating product heuristics from samples. In operation, the example block-batch circuitry 114A constructs batches of data containing information, (e.g., non-matching pairs of products and/or matching pairs of products sometimes referred to herein as hard negatives, easy negatives, positive matches, which are described in further detail below) which trains machine learning models to differentiate between positive pairs (e.g., pairs of products that are considered similar or the same, or a same product identifier) and negative pairs (e.g., pairs of products that are considered different from each other, or not sharing the same product identifier). In some examples, product identifiers (e.g., product IDs) are provided by retailers. In some instances, product identifiers are Universal Product Code (UPC) which have been manually labeled. In other instances, data is marked with product identifiers using human annotation effort(s). The data includes any number of samples from blockings, described in further detail below. Hard negatives, easy negatives, and positive matches are data types that are assigned by the example block-batch circuitry 114A. The batches include data types (e.g., hard negatives, easy negatives, and/or positive matches) which are particular sample pairs or sample groupings labeled as one of these data types so that model training efforts include specificity rather than just random inputs. The problem with using random inputs, in some instances, is that the data may not include enough sample inputs of hard negatives, which means the task of separating positive samples from the rest is easier for the model. Thus, the model will train without the benefit/ability to distinguish minor differences, and the model will fail to predict a non-match when processing two description of similar samples.

When preparing to build batches for training one or more machine learning models, data is retrieved by the block-batch circuitry 114A and it filters the data into blockings based on at least one heuristic. In some examples, the block-batch circuitry 114A filters data using all the heuristics found the retrieved samples. In some instances, a sample may be placed in more than one blocking. In some examples, each blocking represents a product identifier and similar samples matching those heuristics (e.g., same brand, similar price, same color, etc.). In some examples, the blocking includes multiple heuristics consistent with that of a unique sample from the first database 104A and/or second database 106A. The block-batch circuitry 114A retrieves one sample (e.g., product offer) and determines which blockings match the same heuristic(s) as the retrieved sample (e.g., same brand and similar price, etc.). The block-batch circuitry 114A then tests if the sample is a match with any of the samples within the selected blocking (e.g., the product identifier of the retrieved sample matches any of the product identifiers of the samples within the selected blocking). If the sample is a match with any data within the blocking (e.g., the sample has the same heuristic as found in the blocking, or the same product identifier), it constitutes a positive match. If the sample is not a match with at least one sample of data within the blocking (e.g., the sample does not share a same or similar heuristic as those samples in the blocking, or the sample does not share the same product identifier as the blocking), the non-match constitutes a hard negative. For example, if three blockings included fifty, twenty, and ten product offers (e.g., in which each of those eighty products share at least one common heuristic), respectively, and a separate sample product offer (e.g., a sample from another data source, an advertisement, etc.) was compared to all eighty product offers within the example blockings and matched with two of the eighty product offers, there would be two positive matches and seventy-eight hard negatives. If the number of positive matches and hard negatives do not satisfy threshold(s) (e.g., corresponding to a user input), the block-batch circuitry 114A discards the retrieved sample and selects another sample from the first database 104A and/or second database 106A to compare to the blockings. If the number of positive matches and hard negatives satisfies the threshold, the block-batch circuitry 114A tests whether the amount of blockings meets a threshold amount to create a batch. If the amount of blockings do not satisfy the threshold (e.g., corresponding to a user input, corresponding to a stored threshold value based on statistical significance guidelines, etc.), the block-batch circuitry 114A retrieves another sample from the first database 104A and/or second database 106A to compare to the blockings.

Once the amount of positive and/or hard negatives within the blocking satisfies the threshold, the block-batch circuitry 114A compares all samples within the blockings acquired against each other. If the samples within in one blocking is a match with any samples within another blocking, it constitutes a positive match. If the samples within one blocking is not a match with any samples within another blocking, the non-matches constitute easy negatives. The block-batch circuitry 114A combines (e.g., pools, merges, etc.) all the positive matches, easy negatives, and hard negatives into a batch. Thus, the batch includes information about not only from samples that are positive matches, but also samples that are very similar but are actually not a match, which is referred to as hard negatives. For example, the batch will include a positive match having one sample corresponding to a 300 milliliter brown container made by brand X and a second sample corresponding to a 300 milliliter brown container made by brand X. However, the batch will further include a non-match (e.g., hard negative) of one sample a 300-milliliter brown container made by brand X and a third sample, a 250 milliliter brown container made by brand X. In this example, the only difference between sample one and sample three is the volume of the samples. Hence, they are very similar but not a match (e.g., hard negative). This forces the machine learning model to pull together representations of the same concept and push apart representations for different concepts. This ability to distinguish between two very similar samples as non-matches, helps to train models faster, improve accuracy, consume fewer resources, and consequently, saves energy.

FIG. 1B is a schematic diagram of another example environment to build blocking-based batches structured in accordance with teachings of this disclosure. In the illustrated example of FIG. 1B, the example environment to build blocking-based batches 100B (e.g., the “environment”) includes example database(s) 102B, an example dataset 104B, example blocking(s) 106B, an example sample 108B, example similar blockings 110B, 112B, example positive matches 114B, example hard negatives 116B, example easy negatives 118B, and an example batch 120B. In some examples, the dataset 104B is retrieved from database(s) 102B. While the illustrated example of FIG. 1B shows the three databases 102B, examples disclosed herein are not limited thereto. For instance, any number and/or type of data storage may be implemented that is communicatively connected to any number and/or type of processor platform(s) 112A, either directly and/or via the example network 110A as shown in FIG. 1A.

As described in further detail below, the example environment to build blocking-based batches 100B (and/or circuitry therein) acquires and/or retrieves labeled and/or described dataset 104B from databases(s) 102B. The example dataset 104B may include any number of samples 108B. In some instances, the dataset 104B includes receipts with labeled characteristics (e.g., price, date sold, retailer, product ID, product name, etc.). In some examples, the dataset 104B includes samples of labeled data from ecommerce websites and/or labeled training data made for training machine learning models. In operation, the example block-batch circuitry 114A, as shown in FIG. 1A, constructs the batch 120B. The dataset 104B is filtered into blocking(s) 106B based on heuristic(s). For example, if the dataset 104B includes one hundred samples 108B, then the dataset 104B may be filtered into five example blockings (e.g., a brand and retailer blocking with twenty samples, a retailer and color blocking with thirty samples, a volume and color blocking with twenty-five samples, a similar date sold and brand blocking with ten samples, and a volume and brand blocking with fifteen samples). To construct the batch(es) 120B, the block-batch circuitry 114A retrieves the sample 108B from example database(s) 102B. In some examples, the single sample 108B is retrieved from a local data storage 118A as shown in FIG. 1A. The block-batch circuitry 114A then compares the single sample 108B to all the blocking(s) 106B to determine which blocking(s) match the same heuristic(s). In some examples, this may be two similar blockings 110B, 112B as shown in FIG. 1B. These similar blockings 110B, 112B share similar heuristics to the sample 108B. Whereas blocking(s) 106B are built from filtering effort of all the heuristics included in the dataset 104B. For example, if blocking 110B includes samples all sharing the same brand and retailer and matched with the sample 108B, then the sample 108B also shares the same brand and retailer. Furthermore, if the blocking 112B includes samples all sharing the same color and volume and matched with the sample 108B, then the sample 108B also shares the same color and volume. In some examples, the blocking(s) 106B may include samples sharing more than two heuristics. In some examples, the blocking(s) 106B share at least one heuristic.

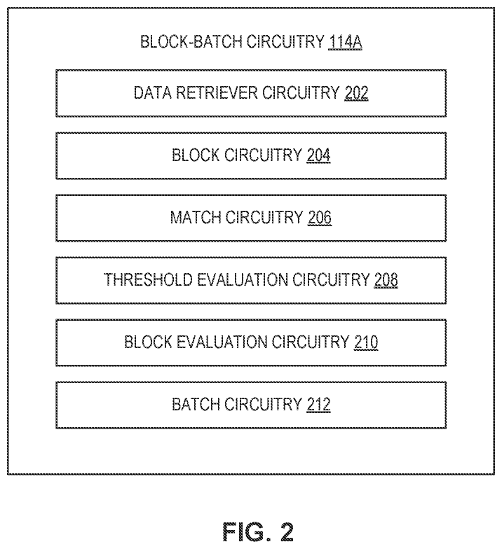

Once the similar blockings 110B, 112B based are matched with the sample 108B, the example block-batch circuitry 114A tests the sample 108B against all samples within the similar blockings 110B, 112B to determine matches and non-matches. The block-batch circuitry 114A adds all samples within the similar blockings 110B, 112B that are an exact match into the example batch 120B as positive matches 114B. The block-batch circuitry 114A further adds all samples within the similar blockings 110B, 112B that are not an exact match into the batch 120B as hard negatives 116B. Further, the block-batch circuitry 114A compares the tested similar blockings 110B, 112B against each other to determine all matches and non-matches. If there are any matches between the samples included in blockings 110B, 112B, then the matches are added to the batch 120B as positive matches. However, all non-matches between the samples included in the blockings 110B, 112B are added to the batch 120B as easy negatives 118B. FIG. 2 illustrates detail corresponding to the example block-batch circuitry 114A of FIG. 1A. In the illustrated example of FIG. 2, the block-batch circuitry includes data retriever circuitry 202, block circuitry 204, match circuitry 206, threshold evaluation circuitry 208, block evaluation circuitry 210, and batch circuitry 212.

The example block-batch circuitry 114A of FIG. 2 builds batches of training information to train and retrain artificial intelligence and/or machine learning models. The block-batch circuitry 114A of FIG. 2 may be instantiated (e.g., creating an instance of, bring into being for any length of time, materialize, implement, etc.) by processor circuitry such as a central processing unit executing instructions. Additionally or alternatively, the block-batch circuitry 114A of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

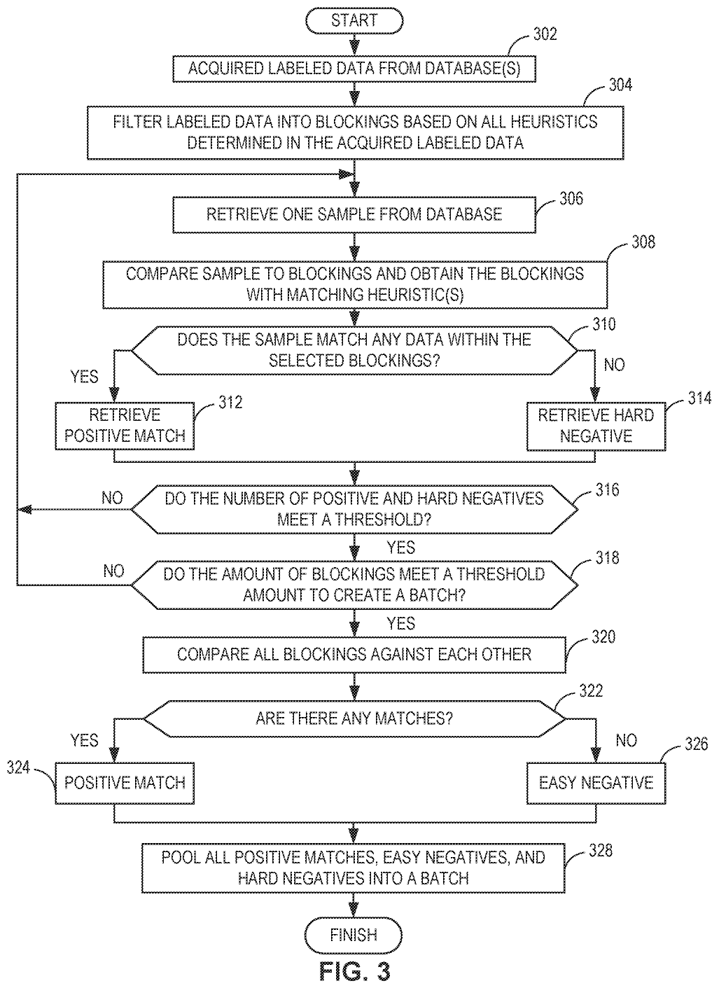

The block-batch circuitry 114A includes data retriever circuitry 202, which retrieves first data 102A and/or second data 108A from the first database 104A and/or second database 106A. The first database 104A and/or second database 106A may be implemented as any type of storage device (e.g., cloud storage, local storage, or network storage). In some examples, the data retriever circuitry 202 is instantiated by processor circuitry executing data retriever instructions and/or configured to perform operations such as those represented by the flowcharts of FIG. 3, discussed in further detail below. The block-batch circuitry 114A also includes the block circuitry 204 which filters retrieved data to generate (e.g., create, produce, etc.) blockings. In some examples, the block circuitry 204 is instantiated by processor circuitry executing block instructions and/or configured to perform operations such as those represented by the flowcharts of FIG. 3, discussed in further detail below. The block-batch circuitry 114A includes the match circuitry 206 to find and/or otherwise match blockings similar to a retrieved sample from the first database 104A and/or second database 106A. This search process is based on heuristics. Additionally, the match circuitry 206 determines if the data within the blocking matches or does not match the sample, in other words, determining the number of positive matches and hard negatives. In some examples, the data within the blocking is determined to be a match based on sharing the same product identifier. In some examples, the match circuitry 206 assigns (e.g., designates, labels, allocates, etc.) the data, respectively, positive matches (e.g., first designation types) or hard negatives (e.g., second designation types). In some examples, the match circuitry 206 is instantiated by processor circuitry executing match instructions and/or configured to perform operations such as those represented by the flowcharts of FIG. 3, discussed in further detail below. The block-batch circuitry 114A includes the threshold evaluation circuitry 208 to evaluate whether the number of positive matches and hard negatives meets threshold metrics (e.g., established by a user, a retailer, a market researcher, metrics based on historical best practices, etc.). If the number of positive matches and hard negatives meet threshold metrics (e.g., an indication that the block-batch circuitry 114A is determining matches with desired expectations), then the block evaluation circuitry 210 evaluates the number of blockings thus far assessed (e.g., evaluated for positive matches and/or hard negatives) to a threshold amount required to form a batch. However, if the number of positive matches and hard negatives do not meet threshold metrics (e.g., an indication that the block-batch circuitry 114A is underperforming and/or otherwise failing to distinguish between matching and non-matching samples), then the match circuitry 206 discards the blocking and another sample is retrieved from the first database 104A and/or second database 106A. In some examples, the threshold evaluation circuitry 208 is instantiated by processor circuitry executing threshold evaluation instructions and/or configured to perform operations such as those represented by the flowcharts of FIG. 3, discussed in further detail below. In some examples, the block evaluation circuitry 210 is instantiated by processor circuitry executing block evaluation instructions and/or configured to perform operations such as those represented by the flowcharts of FIG. 3, discussed in further detail below.

Additionally, if the block evaluation circuitry 210 evaluates that the number of blockings meets the threshold amount of blockings to form a batch, then the match circuitry 206 compares all the blockings against each other. If the match circuitry 206 determines a match between two blocking's samples, it constitutes a positive match. If the match circuitry 206 determines non-matches between two blockings, the non-matches constitute easy negatives. In some examples, the match circuitry 206 assigns (e.g., designates, labels, allocates, etc.) the non-matches as easy negatives (e.g., third designation types). However, if the block evaluation circuitry 210 evaluates that the number of blockings do not satisfy the threshold amount of blockings to form a batch, then data retriever circuitry 202 is initiated to retrieve (e.g., obtain) another sample from the first database 104A and/or second database 106A. In some examples, the block evaluation circuitry 210 is instantiated by processor circuitry executing block evaluation instructions and/or configured to perform operations such as those represented by the flowcharts of FIG. 3, discussed in further detail below. In addition, the batch circuitry 212 combines (e.g., pools, merges, etc.) all the positive matches, easy negatives, and hard negatives into the batch. Further, the batch circuitry causes machine learning training to begin and/or otherwise instantiate a machine learning process based on the batch (e.g., the machine learning input batch). In some examples, the batch circuitry 212 is instantiated by processor circuitry executing batch instructions and/or configured to perform operations such as those represented by the flowcharts of FIG. 3, discussed in further detail below.

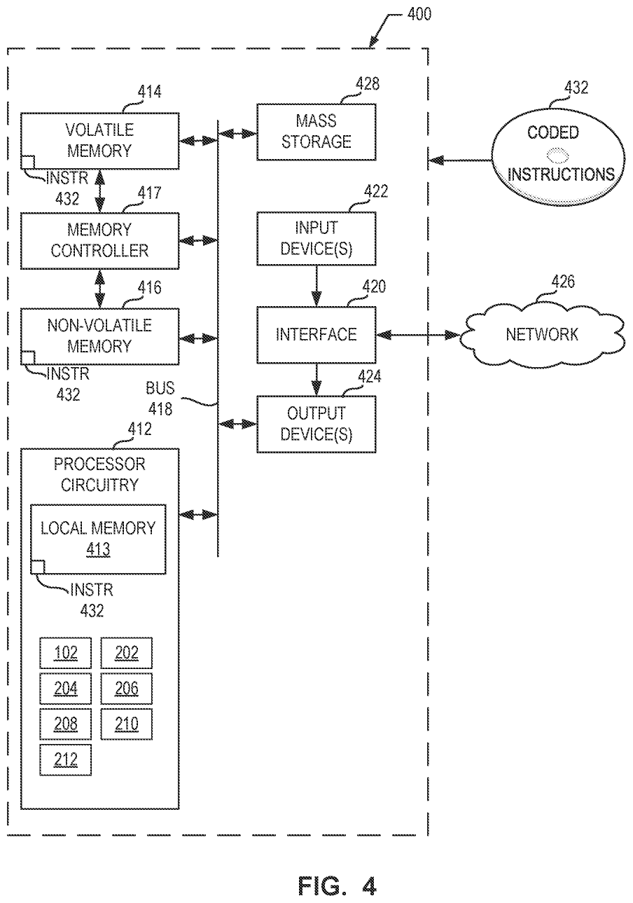

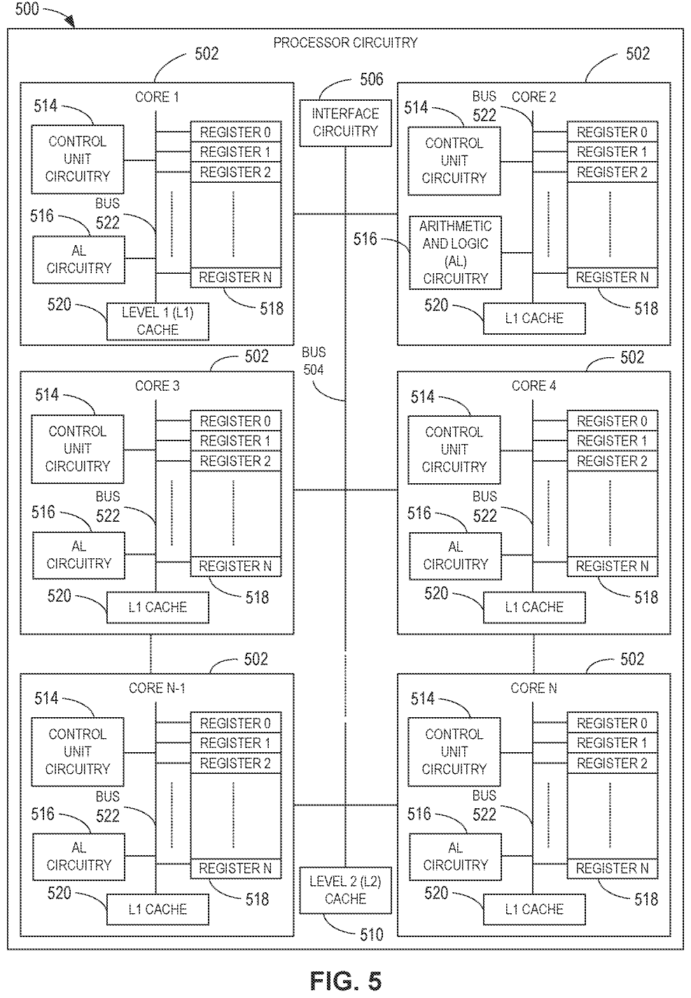

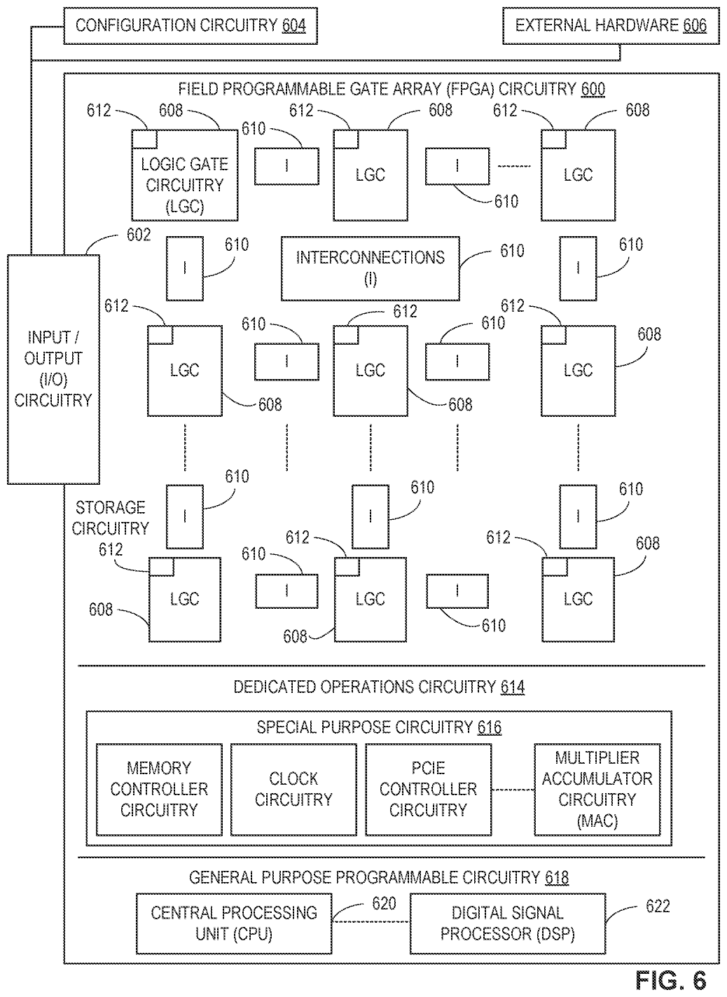

In some examples, the block-batch circuitry 114A includes means for retrieving data, means for filtering data in blockings, means for comparing samples within blockings, means for determining threshold metrics, means for evaluating metrics, means for comparing blockings, and means for combining (e.g., pooling, compiling, merging, etc.) matches and non-matches. In some examples, the aforementioned circuitry may be instantiated by processor circuitry such as the example processor circuitry 412 of FIG. 4. For instance, the aforementioned circuitry may be instantiated by the example microprocessor 500 of FIG. 5 executing machine executable instructions such as those implemented by at least blocks of FIG. 3. In some examples, the aforementioned circuitry may be instantiated by hardware logic circuitry, which may be implemented by an ASIC, XPU, or the FPGA circuitry 600 of FIG. 6 structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In execution, AI and/or machine learning models may be fed any number of batches during training. The following example is one example environment to build a single batch for training AI and/or machine learning models. As such, the example block-batch circuitry 114A invokes the data retriever circuitry 202 to acquire and/or otherwise obtain first data 102A and/or second data 108A from first database 104A and/or second database 106A. In some examples, the first data 102A and/or second data 108A is labeled with descriptions and/or heuristics (e.g., brand, color, price, date sold, retailer, etc.). The example block-batch circuitry 114A invokes the block circuitry 204 to filter the acquired and/or obtained data into blockings based on the labeled descriptions, heuristics, attributes, and/or characteristic (e.g., brand, color, price, date sold, retailer, etc.). For example, if a hundred samples of data are acquired and/or obtained from first database 104A and/or second database 106A, then the example block circuitry 204 distributes the hundred samples into blocking(s) sharing some of those heuristics (e.g., fifty samples sharing color and brand makes a blocking, twenty-five samples sharing brand and similar price make a second blocking, and forty samples sold on the same date and have similar descriptions make a third blocking). In some examples, samples differing in one attribute can group in overlapping blockings. For example, a white chocolate bar (e.g., Toblerone, Hershey, etc.) and a dark chocolate bar (e.g., Toblerone, Hershey, etc.) may be included in blockings that group all samples of the chocolate category with a price close to two euros and containing words similar to bar (e.g., Toblerone, Hershey, etc.). Stated differently, a sample may be included in more than one blocking. For example, one sample in the acquired and/or obtained data may belong to both the color blocking and the brand blocking.

The example block-batch circuitry 114A invokes the data retriever circuitry 204 to retrieve a single sample from first database 104A or second database 106A. In some examples, the data retriever circuity retrieves a single sample from within a blocking. The example block-batch circuitry then invokes the match circuitry 206 to compare the single sample to the blockings to find blocking(s) that share some heuristic to the single sample. For the sake of this example, assume the single sample is similar to three blockings because the single sample shares the same brand and has similar prices. Once the similar blocking is determined, the example match circuitry 206 compares the single sample to the data included within the blocking(s) (e.g., the three blockings sharing brand and price) to find match and/or non-matches. The example match circuitry 206 labels all matches as positive matches and all non-matches as hard negatives. The hard negatives (sometimes referred to herein as difficult negatives) as are determined to be hard (e.g., difficult) because the sample retrieved and the sample within one of the similar blocking(s) being compared share some heuristic (e.g., brand and color, color and price, price and date sold, date sold and brand, retailer and text similarity, color, brand and retailer, etc.), however, are determined to not be a match. A hard negative is two samples close in descriptions but are not an exact match. For example, two seltzers from the same brand, however, one is sold as a 200 milliliter container and the second is sold as a 50 milliliter container.

The example block-batch circuitry 114A invokes the threshold evaluation circuitry 208 to determine whether the number of positive matches and hard negatives meet a threshold amount. If the threshold evaluation circuitry 208 detects insufficient positive matches and hard negatives, the match circuitry 206 discards the sample and blocking(s) and process loops to retrieve another sample from the first database 104A and/or second database 106A. If the threshold evaluation circuitry 208 determines a sufficient quantity of positive matches and hard negatives (e.g., at least two positive matches and ninety hard negatives in a blocking of 100 sample), block-batch circuitry 114A invokes the block evaluation circuitry 210. The block evaluation circuitry 210 detects if the number of blockings processed meets a threshold amount to create a batch. If the number of processed blockings does not meet the threshold, the block-batch circuitry 114A permits the data retriever circuitry 204 to retrieve another sample and process loops until the user threshold amount of blockings is met. If the amount/quantity of blockings meets the threshold amount/quantity to create a batch, then the block-batch circuitry 114A initiates the match circuitry 206 to compare all the processed blockings against each other. During this comparison, the match circuitry 206 will label matches as positive matches and non-matches as easy negatives. The easy negatives are two samples from different blockings that are determined to be non-matches. They are labeled “easy” because the samples were not determined to share a common heuristic by the example block circuitry 204 and, as such, there is no ambiguity in determining that they are dissimilar samples.

The example block-batch circuitry 114A invokes the batch circuitry 212 to combine (e.g., pool, merges, etc.) all the positive matches, easy negatives, and hard negatives found during the process into a batch. This batch creation strategy forces the machine learning model to distinguish between positive and hard negative matches that have similar text sequences, as they belong to the same blocking. Further, this process forces the machine learning model to distinguish between positive and easy negative from unrelated samples coming from the different blockings. This process allows for more discriminative product embedding included in the batches. Thus, the machine learning models are trained and retrained faster and more effectively. Moreover, fewer computational resources are required to train or retrain the models.

While an example manner of the environment to build blocking-based batches 100A of FIG. 1A is illustrated in FIG. 2, one or more of the elements, processes, and/or devices illustrated in FIG. 2 may be combined, divided, re-arranged, omitted, eliminated, and/or implemented in any other way. Further, the example block-batch circuitry 114A, the data retriever circuitry 202, the block circuitry 204, the match circuitry 206, the threshold evaluation circuitry 208, the block evaluation 210, the batch circuitry 212 and/or, more generally, the example environment to build blocking-based batches 100A of FIG. 1A, may be implemented by hardware alone or by hardware in combination with software and/or firmware. Thus, for example, any of the example the example block-batch circuitry 114A, the data retriever circuitry 202, the block circuitry 204, the match circuitry 206, the threshold evaluation circuitry 208, the block evaluation 210, the batch circuitry 212 and/or, more generally, the example environment to build blocking-based batches 100A, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example environment to build blocking-based batches 100A of FIG. 1A may include one or more elements, processes, and/or devices in addition to, or instead of, those illustrated in FIGS. 1 and/or 2, and/or may include more than one of any or all of the illustrated elements, processes and devices.

A flowchart representative of example machine readable instructions, which may be executed to configure processor circuitry to implement the environment to build blocking-based batches of FIGS. 1A-2, is shown in FIG. 3. The machine readable instructions may be one or more executable programs or portion(s) of an executable program for execution by processor circuitry, such as the processor circuitry 412 shown in the example processor platform 400 discussed below in connection with FIG. 4 and/or the example processor circuitry discussed below in connection with FIGS. 5 and/or 6. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 3, many other methods of implementing the example environment to build blocking-based batches may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 3 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to build batches for training and retraining machine learning models (e.g., product matching). The machine readable instructions and/or the operations 300 of FIG. 3 begin at sequence 302, at which the data retriever circuitry 202 downloads first data 102A and/or second data 108A, (e.g., image data, image data with embedded text, etc.) from storage (e.g., the example first database 104A and/or second database 106A, the local data storage 118A, etc.). The block circuitry 204 filters the first data 102A and/or second data 108A (e.g., image data, image data with embedded text, etc.) into blockings based on heuristics (sequence 304). The example data retriever circuitry 202 retrieves one sample from storage (e.g., the example first database 104A and/or second database 106A, the local data storage 118A, etc.) (sequence 306). The example match circuitry 206 compares the sample to the blockings and determines the similar blocking(s) (sequence 308). In some examples, two samples with the same brand and color are similar. However, two samples with the same brand but different volumes are not similar. In other examples, the match circuitry 206 determines degrees of similarity between two or more samples. For instance, in the event there are three heuristics of interest, then the example match circuitry 206 generates a similarity score based on a quantity of heuristics that match each other. As such, if all three heuristics are present in a comparison between two samples, then there is a 100% match, thereby the samples are labeled as similar. In contrary, if two heuristics are present in a comparison between two sample, then there is about 67% match, thereby not as similar as the 100% match. The match circuitry 206 checks if the sample matches any of the data (e.g., one or more samples) within the blocking (sequence 310), and if there is a match, the example match circuitry 206 retrieves the pair as a positive match (sequence 312). The match circuitry 206 retrieves all non-matching data from the blocking as hard negatives (sequence 314). The threshold evaluation circuitry 208 checks whether the amount of positive matches and/or hard negative(s) meet the threshold metric (sequence 316).

If the test results are determined not acceptable based on threshold metrics, the match circuitry 206 returns to sequence 306 and another sample is retrieved to be compared to the blocking(s). If the test results are determined acceptable (sequence 316), the block evaluation circuitry 210 tests whether the amount/quantity of blockings processed meets a threshold amount to create a batch (e.g., a machine learning input batch) (sequence 318). If the test results are determined not acceptable (sequence 318), the data retriever circuitry 202 returns to sequence 306 to retrieve a new sample from storage (e.g., the example first database 104A and second database 106A, the local data storage 118A, etc.). If the test results are determined acceptable (sequence 318), then the match circuitry 206 is engaged to compare all processed blockings against each other (sequence 320). In some examples, the samples within one blocking are compared against the samples within a second blocking. For examples, the brand blocking's samples (e.g., all samples sharing the same brand) and the retailer blocking's samples (e.g., all samples sharing the same retailer) are compared against one another. The example match circuitry 206 tests whether there are any matches (sequence 322). If there is a match, the match circuitry 206 marks the pair as a positive match (sequence 324), and all other none matches data between the two blockings are marked as easy negatives (sequence 326). The batch circuitry 212 combines (e.g., pools, merges, etc.) all marked positive matches, hard negatives, and/or easy negatives into a batch (sequence 328). Once the batch is completed, the process is finished, and the batch is ready to be fed to machine learning models for training and/or retraining.

FIG. 4 is a block diagram of an example processor platform 400 structured to execute and/or instantiate the machine readable instructions and/or the operations of FIG. 3 to implement the environment to build blocking-based batches of FIG. 1-2. The processor platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a set top box, or any other type of computing device.

The processor platform 400 of the illustrated example includes processor circuitry 412. The processor circuitry 412 of the illustrated example is hardware. For example, the processor circuitry 412 can be implemented by one or more integrated circuits, logic circuits, FPGAs, microprocessors, CPUs, GPUs, DSPs, and/or microcontrollers from any desired family or manufacturer. The processor circuitry 412 may be implemented by one or more semiconductor based (e.g., silicon based) devices. In this example, the processor circuitry 412 implements the data retriever circuitry 202, the block circuitry 204, the match circuitry 206, the threshold evaluation circuitry 208, the block evaluation 210, and the batch circuitry 208.

The processor circuitry 412 of the illustrated example includes a local memory 413 (e.g., a cache, registers, etc.). The processor circuitry 412 of the illustrated example is in communication with a main memory including a volatile memory 414 and a non-volatile memory 416 by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417.

The processor platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user to enter data and/or commands into the processor circuitry 412. The input device(s) 422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 400 of the illustrated example also includes one or more mass storage devices 428 to store software and/or data. Examples of such mass storage devices 428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 432, which may be implemented by the machine readable instructions of FIG. 3, may be stored in the mass storage device 428, in the volatile memory 414, in the non-volatile memory 416, and/or on a removable non-transitory computer readable storage medium such as a CD or DVD.

FIG. 5 is a block diagram of an example implementation of the processor circuitry 412 of FIG. 4. In this example, the processor circuitry 412 of FIG. 4 is implemented by a microprocessor 500. For example, the microprocessor 500 may be a general purpose microprocessor (e.g., general purpose microprocessor circuitry). The microprocessor 500 executes some or all of the machine readable instructions of the flowchart of FIG. 3 to effectively instantiate the block-batch circuitry 114A of FIGS. 1A and 2 as logic circuits to perform the operations corresponding to those machine readable instructions. In some such examples, the block-batch circuitry 114A of FIG. 1A and is instantiated by the hardware circuits of the microprocessor 500 in combination with the instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowchart of FIG. 3.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating point operations. In yet other examples, the AL circuitry 516 may include first AL circuitry that performs integer based operations and second AL circuitry that performs floating point operations. In some examples, the AL circuitry 516 may be referred to as an Arithmetic Logic Unit (ALU). The registers 518 are semiconductor-based structures to store data and/or instructions such as results of one or more of the operations performed by the AL circuitry 516 of the corresponding core 502. For example, the registers 518 may include vector register(s), SIMD register(s), general purpose register(s), flag register(s), segment register(s), machine specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure including distributed throughout the core 502 to shorten access time. The second bus 522 may be implemented by at least one of an I2C bus, a SPI bus, a PCI bus, or a PCIe bus

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 6 is a block diagram of another example implementation of the processor circuitry 412 of FIG. 4. In this example, the processor circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the machine readable instructions in hardware and, thus, can often execute the operations faster than they could be performed by a general purpose microprocessor executing the corresponding software.

More specifically, in contrast to the microprocessor 500 of FIG. 5 described above (which is a general purpose device that may be programmed to execute some or all of the machine readable instructions represented by the flowchart of FIG. 3 but whose interconnections and logic circuitry are fixed once fabricated), the FPGA circuitry 600 of the example of FIG. 6 includes interconnections and logic circuitry that may be configured and/or interconnected in different ways after fabrication to instantiate, for example, some or all of the machine readable instructions represented by the flowchart of FIG. 3. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the software represented by the flowchart of FIG. 3. As such, the FPGA circuitry 600 may be structured to effectively instantiate some or all of the machine readable instructions of the flowchart of FIG. 3 as dedicated logic circuits to perform the operations corresponding to those software instructions in a dedicated manner analogous to an ASIC. Therefore, the FPGA circuitry 600 may perform the operations corresponding to the some or all of the machine readable instructions of FIG. 3 faster than the general purpose microprocessor can execute the same.

In the example of FIG. 6, the FPGA circuitry 600 is structured to be programmed (and/or reprogrammed one or more times) by an end user by a hardware description language (HDL) such as Verilog. The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain machine readable instructions to configure the FPGA circuitry 600, or portion(s) thereof In some such examples, the configuration circuitry 604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 606 may be implemented by external hardware circuitry. For example, the external hardware 606 may be implemented by the microprocessor 500 of FIG. 5. The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations that may correspond to at least some of the machine readable instructions of FIG. 3 and/or other desired operations. The logic gate circuitry 608 shown in FIG. 6 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example Dedicated Operations Circuitry 614. In this example, the Dedicated Operations Circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the processor circuitry 412 of FIG. 4, many other approaches are contemplated. For example, as mentioned above, modern FPGA circuitry may include an on-board CPU, such as one or more of the example CPU 620 of FIG. 6. Therefore, the processor circuitry 412 of FIG. 4 may additionally be implemented by combining the example microprocessor 500 of FIG. 5 and the example FPGA circuitry 600 of FIG. 6. In some such hybrid examples, a first portion of the machine readable instructions represented by the flowchart of FIG. 3 may be executed by one or more of the cores 502 of FIG. 5, a second portion of the machine readable instructions represented by the flowchart of FIG. 3 may be executed by the FPGA circuitry 600 of FIG. 6, and/or a third portion of the machine readable instructions represented by the flowchart of FIG. 3 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the processor circuitry 412 of FIG. 4, which may be in one or more packages. For example, the XPU may include a CPU in one package, a DSP in another package, a GPU in yet another package, and an FPGA in still yet another package.

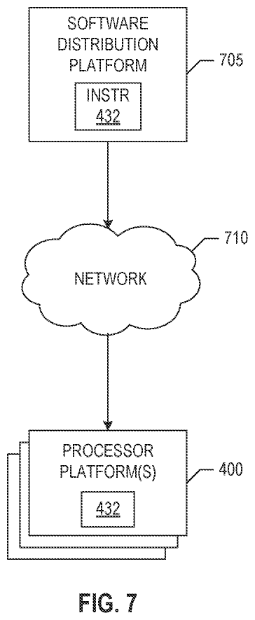

A block diagram illustrating an example software distribution platform 705 to distribute software such as the example machine readable instructions 432 of FIG. 4 to hardware devices owned and/or operated by third parties is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions 300 of FIG. 3, as described above. The one or more servers of the example software distribution platform 705 are in communication with an example network 410, which may correspond to any one or more of the Internet and/or any of the example networks 426 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 432 from the software distribution platform 705. For example, the software, which may correspond to the example machine readable instructions 300 of FIG. 3, may be downloaded to the example processor platform 400, which is to execute the machine readable instructions 432 to implement the block-batch circuitry 114A. In some examples, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices.

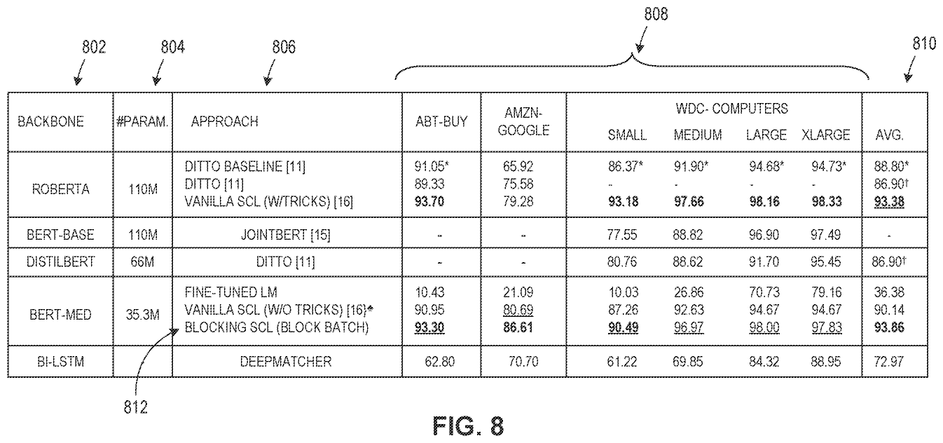

FIG. 8 is a table of test results comparing different model training approaches. The table reports the resulting F1 scores from machine learning models training with conventional methods and the block-batch method. The data used to perform the training is from the six most commonly used public datasets 808. In some examples, the F1 score is calculated as precision multiplied by recall and divided by the sum of precision plus recall, the result then multiplied by two (e.g., in a manner consistent with example Equation 1).

$$F 1 = 2 * \frac{Precision * Recall}{( Precision + Recall )} \qquad Equation 1$$

In FIG. 8, the column backbone 802 lists machine learning models. The column #param. 804 lists the number of parameters required from a processing unit to run the training method. The column approach 806 lists the method being used to train the machine learning model. The following six column are the six most commonly used public datasets 808. The column avg. 810 is a list of the average F1 scores for each of the approaches. Blocking SCL (block-batch) is consistent with the examples disclosed in FIGS. 1A-3. The row blocking SCL (block-batch) 812 list the F1 score using the approach described herein to train models.

The Blocking SCL (block-batch) method F1 score surpasses by a large margin (␣7.3) the results of the previous top-performing method in the Amazon-Google dataset. This dataset is the less saturated one in terms of performance, giving sufficient room for improvement. Unlike the other five datasets, where related work performance ranges from 93.16 up to 98.1 F1-scores. In the remaining of the six commonly used public datasets 808, the blocking SCL (block-batch) method achieves comparable results to using a model three times smaller and a more modest training strategy (e.g., smaller batch-sizes and input sequences). The blocking SCL (block-batch) is able to perform training using less parameters while still achieving better, or about equal, F1 scores as other approaches listed. Thus, the blocking SCL (block-batch) reduces the amount of computational resources required to effectively train machine learning models.

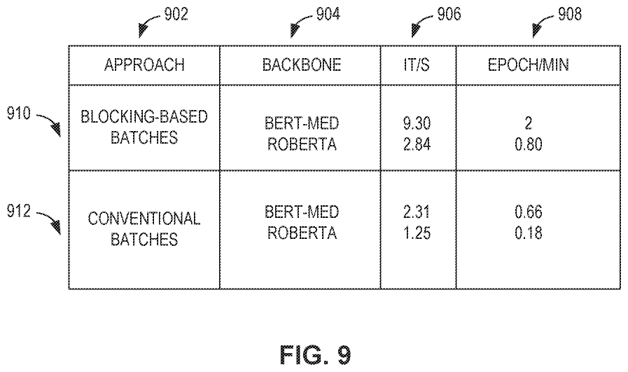

FIG. 9 is a table comparing computational time between different model training approaches. The first column approach 902 lists the training approaches (e.g., training blocking-based batches or conventional batches). The second column backbone 904 lists the machine learning model used to test the computation time difference between the two approaches. The third column it/s 906 lists the iteration per a second the machine learning model is able to compute for each approach. The fourth column epoch/min 908 lists the epoch per a minute the machine learning model can compute for each approach. An epoch is when all the defined batches are passed forward and backward through the model (neural network) once. In some examples, a batch or a set of batches do not contain all the examples in the dataset. The data is typically randomly selected, thus, a sample may not be included. In some instances, the number of batches is proportional to the amount of data, so that the amount of samples (grouped in batches) processed by a neural network in one epoch coincides with the amount of samples in the dataset.

Regarding efficiency, the evaluation of the difference between computing times is shown in FIG. 9. The blocking-based batches 910 are more efficient, performing computations at a rate of four times and two times faster than the conventional batches 912 using models BERT-med and RoBERTa, respectively. Thus, building complex batches with hard negatives, easy negative, and/or positive matches brings computational benefits during training, leading the convergence of the model to a more optimal minimum, without requiring large architectures. In other words, the blocking-based batches 910 are able achieve lower loss function values which represent how effective the model processes data (e.g., the output data given known input data). Thus, during training, focusing on the separability of the sample representations results in the model's final matching task to be more effective and efficient.

From the foregoing, it will be appreciated that example systems, methods, apparatus, and articles of manufacture have been disclosed that reduce the consumption of computing resources in circumstances where models trained. The examples disclosed herein do not discard useful training information during the blocking stage, and instead, include the complex information in batch construction to feed machine learning models during training. Disclosed systems, methods, apparatus, and articles of manufacture improve the efficiency of using a computing device by building batches with complex information (e.g., hard negative). Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to build blocking-based batches for training machine learning models are disclosed herein. Further examples and combinations thereof include the following:
Example 1 includes an apparatus to improve model training efficiency, the apparatus comprising block circuitry to generate a first blocking corresponding to first ones of first data samples retrieved from a first data source, the first ones of the first data samples including a first heuristic, and generate a second blocking corresponding to second ones of the first data samples that include a second heuristic, match circuitry to retrieve a second data sample from a second data source and determine a match of the first blocking or the second blocking, the match based on whether the data sample includes a respective first heuristic or second heuristic, and assign respective ones of the first data samples from the match one of a first designation type or a second designation type based on whether the respective ones of the first data samples from the match include a matching first and second heuristic to the second data sample, and batch circuitry to combine the first designation type and the second designation type into a machine learning input batch, and cause machine learning training to begin based on the machine learning input batch.
Example 2 includes the apparatus as defined in example 1, wherein the match circuitry is to compare the first blocking against the second blocking, and assign respective ones of the first data samples a third designation type, the batch circuitry to combine the first designation type, the second designation type and the third designation type into the machine learning input batch.
Example 3 includes the apparatus as defined in example 1, wherein the first blocking or the second blocking includes at least one of the second heuristic or the first heuristic, respectively.
Example 4 includes the apparatus as defined in example 1, wherein the block circuitry is to generate a plurality of blockings corresponding to the first data samples that include a plurality of heuristics.
Example 5 includes the apparatus as defined in example 1, wherein the second data source includes the first data source.
Example 6 includes the apparatus as defined in example 1, wherein the first data samples and the second data sample are labeled with the first heuristic and the second heuristic, respectively.
Example 7 includes the apparatus as defined in example 6, wherein the first heuristic or the second heuristic includes one of brand, product identifier, color, price, small price difference, date sold, or retailer.
Example 8 includes an apparatus to improve model training efficiency comprising at least one memory, machine readable instructions, and processor circuitry to at least one of instantiate or execute the machine readable instructions to create a first blocking corresponding to first ones of first data samples retrieved from a first data source, the first ones of the first data samples including a first characteristic, and create a second blocking corresponding to second ones of the first data samples that include a second characteristic, retrieve a second data sample from a second data source and determine a match from the first blocking or the second blocking, the match based on whether the data sample shares a respective first characteristic or second characteristic, and designate respective ones of the first data samples from the matching one of a first designation type or a second designation type based on whether the respective ones of the first data samples from the match include a matching first and second heuristic to the second data sample, and merge the first designation type and the second designation type into a machine learning input batch, and causing machine learning training to begin based on the machine learning input batch.
Example 9 includes the apparatus as defined in example 8, wherein the processor circuitry is to evaluate the first blocking against the second blocking, and designate respective ones of the first data samples a third designation type, the processor circuitry to combine the first designation type, the second designation type and the third designation type into the machine learning input batch.
Example 10 includes the apparatus as defined in example 8, wherein the first blocking or the second blocking includes at least one of the second characteristic or the first characteristic, respectively.
Example 11 includes the apparatus as defined in example 8, wherein the processor circuitry is to generate a plurality of blockings corresponding to the first data samples that include a plurality of characteristics.
Example 12 includes the apparatus as defined in example 8, wherein the second data source includes the first data source.
Example 13 includes the apparatus as defined in example 8, wherein the first data samples and the second data samples are labeled with the first characteristic and the second characteristic, respectively.
Example 14 includes the apparatus as defined in example 13, wherein the first characteristic or the second characteristic includes one of brand, product identifier, color, price, small price difference, date sold, or retailer.
Example 15 includes a non-transitory machine readable storage medium comprising instructions that, when executed, cause processor circuitry to at least produce a first blocking corresponding to first ones of first data samples retrieved from a first data source, the first ones of the first data samples including a first heuristic, and produce a second blocking corresponding to second ones of the first data samples that include a second heuristic, acquires a data sample from a second data source and determine a match of the first blocking or the second blocking, the match based on whether the data sample shares a respective first heuristic or second heuristic, and allocate respective ones of the first data samples from the match one of a first designation type or a second designation type based on whether the respective ones of a second data samples include a matching first or second heuristic, and combine the first designation type and the second designation type into a machine learning input batch, and cause machine learning training to begin based on the machine learning input batch.
Example 16 includes the non-transitory machine readable storage medium as defined in example 15, wherein the processor circuitry is to compare the first blocking against the second blocking, and assign respective ones of the first data samples a third designation type, the batch circuitry to combine the first designation type, the second designation type and the third designation type into the machine learning input batch.
Example 17 includes the non-transitory machine readable storage medium as defined in example 15, wherein the first blocking or the second blocking includes at least one of the second heuristic or the first heuristic, respectively.
Example 18 includes the non-transitory machine readable storage medium as defined in example 15, wherein the processor circuitry is to generate a plurality of blockings corresponding to the first data samples that include a plurality of heuristics.
Example 19 includes the non-transitory machine readable storage medium as defined in example 15, wherein the second data source includes the first data source.
Example 20 includes the non-transitory machine readable storage medium as defined in example 15, wherein the first data samples and the second data samples are labeled with the first heuristic and the second heuristic, respectively.
Example 21 includes the non-transitory machine readable storage medium as defined in example 20, wherein the first heuristic or the second heuristic is any one of brand, product identifier, color, price, small price difference, date sold, or retailer.
Example 22 includes a method of improving model training efficiency, the method comprising generating, by executing instructions with at least one processor, a first blocking corresponding to first ones of first data samples retrieved from a first data source that include a first heuristic, and generating, by executing instructions with the at least one processor, a second blocking corresponding to second ones of the first data samples that include a second heuristic, retrieving, by executing instructions with the at least one processor, a data sample from a second data source and determine a match of the first blocking or the second blocking based on whether the data sample shares a respective first heuristic or second heuristic, and assigning, by executing instructions with the at least one processor, respective ones of the first data samples from the match one of a first designation type or a second designation type based on whether the respective ones of a second data samples include a matching first or second heuristic, and combining, by executing instructions with the at least one processor, the first designation type and the second designation type into a machine learning input batch, and causing, by executing instructions with the at least one processor, machine learning training to begin based on the machine learning input batch.
Example 23 includes the method of example 22, wherein the method includes comparing the first blocking against the second blocking, and assigning respective ones of the first data samples a third designation type, the batch circuitry to combine the first designation type, the second designation type and the third designation type into the machine learning input batch.
Example 24 includes the method as defined in example 22, wherein the first blocking or the second blocking includes at least one of the second heuristic or the first heuristic, respectively.
Example 25 includes the method as defined in example 22, wherein the method includes generating a plurality of blockings corresponding to the first data samples that include a plurality of heuristics.
Example 26 includes the method as defined in example 22, wherein the second data source includes the first data source.
Example 27 includes the method as defined in example 22, wherein the first data samples and the second data samples are labeled with the first heuristic and the second heuristic, respectively.
Example 28 includes the method as defined in example 27, wherein the first heuristic or the second heuristic is any one of brand, product identifier, color, price, small price difference, date sold, or retailer.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to improve model training efficiency, the apparatus comprising:
block circuitry to:
generate a first blocking corresponding to first ones of first data samples retrieved from a first data source, the first ones of the first data samples including a first heuristic; and
generate a second blocking corresponding to second ones of the first data samples that include a second heuristic;
match circuitry to:
retrieve a second data sample from a second data source and determine a match of the first blocking or the second blocking, the match based on whether the data sample includes a respective first heuristic or second heuristic; and
assign respective ones of the first data samples from the match one of a first designation type or a second designation type based on whether the respective ones of the first data samples from the match include a matching first and second heuristic to the second data sample; and
batch circuitry to:
combine the first designation type and the second designation type into a machine learning input batch; and
cause machine learning training to begin based on the machine learning input batch.

2. The apparatus as defined in claim 1, wherein the match circuitry is to:
compare the first blocking against the second blocking; and
assign respective ones of the first data samples a third designation type, the batch circuitry to combine the first designation type, the second designation type and the third designation type into the machine learning input batch.

3. The apparatus as defined in claim 1, wherein the first blocking or the second blocking includes at least one of the second heuristic or the first heuristic, respectively.

4. The apparatus as defined in claim 1, wherein the block circuitry is to generate a plurality of blockings corresponding to the first data samples that include a plurality of heuristics.

5. The apparatus as defined in claim 1, wherein the second data source includes the first data source.

6. The apparatus as defined in claim 1, wherein the first data samples and the second data sample are labeled with the first heuristic and the second heuristic, respectively.

7. The apparatus as defined in claim 6, wherein the first heuristic or the second heuristic includes one of brand, product identifier, color, price, small price difference, date sold, or retailer.

8. An apparatus to improve model training efficiency comprising:
at least one memory;
machine readable instructions; and
processor circuitry to at least one of instantiate or execute the machine readable instructions to:
create a first blocking corresponding to first ones of first data samples retrieved from a first data source, the first ones of the first data samples including a first characteristic; and
create a second blocking corresponding to second ones of the first data samples that include a second characteristic;
retrieve a second data sample from a second data source and determine a match from the first blocking or the second blocking, the match based on whether the data sample shares a respective first characteristic or second characteristic; and
designate respective ones of the first data samples from the matching one of a first designation type or a second designation type based on whether the respective ones of the first data samples from the match include a matching first and second heuristic to the second data sample; and
merge the first designation type and the second designation type into a machine learning input batch; and
causing machine learning training to begin based on the machine learning input batch.

9. The apparatus as defined in claim 8, wherein the processor circuitry is to:
evaluate the first blocking against the second blocking; and
designate respective ones of the first data samples a third designation type, the processor circuitry to combine the first designation type, the second designation type and the third designation type into the machine learning input batch.

10. The apparatus as defined in claim 8, wherein the first blocking or the second blocking includes at least one of the second characteristic or the first characteristic, respectively.

11. The apparatus as defined in claim 8, wherein the processor circuitry is to generate a plurality of blockings corresponding to the first data samples that include a plurality of characteristics.

12. The apparatus as defined in claim 8, wherein the second data source includes the first data source.

13. The apparatus as defined in claim 8, wherein the first data samples and the second data samples are labeled with the first characteristic and the second characteristic, respectively.

14. The apparatus as defined in claim 13, wherein the first characteristic or the second characteristic includes one of brand, product identifier, color, price, small price difference, date sold, or retailer.

15. A non-transitory machine readable storage medium comprising instructions that, when executed, cause processor circuitry to at least:
produce a first blocking corresponding to first ones of first data samples retrieved from a first data source, the first ones of the first data samples including a first heuristic; and
produce a second blocking corresponding to second ones of the first data samples that include a second heuristic;
acquires a data sample from a second data source and determine a match of the first blocking or the second blocking, the match based on whether the data sample shares a respective first heuristic or second heuristic; and
allocate respective ones of the first data samples from the match one of a first designation type or a second designation type based on whether the respective ones of a second data samples include a matching first or second heuristic; and
combine the first designation type and the second designation type into a machine learning input batch; and
cause machine learning training to begin based on the machine learning input batch.

16. The non-transitory machine readable storage medium as defined in claim 15, wherein the processor circuitry is to:
compare the first blocking against the second blocking; and
assign respective ones of the first data samples a third designation type, the batch circuitry to combine the first designation type, the second designation type and the third designation type into the machine learning input batch.

17. The non-transitory machine readable storage medium as defined in claim 15, wherein the first blocking or the second blocking includes at least one of the second heuristic or the first heuristic, respectively.

18. The non-transitory machine readable storage medium as defined in claim 15, wherein the processor circuitry is to generate a plurality of blockings corresponding to the first data samples that include a plurality of heuristics.

19. The non-transitory machine readable storage medium as defined in claim 15, wherein the second data source includes the first data source.

20. The non-transitory machine readable storage medium as defined in claim 15, wherein the first data samples and the second data samples are labeled with the first heuristic and the second heuristic, respectively.

21. The non-transitory machine readable storage medium as defined in claim 20, wherein the first heuristic or the second heuristic is any one of brand, product identifier, color, price, small price difference, date sold, or retailer.

22. (canceled)

23. (canceled)

24. (canceled)

25. (canceled)

26. (canceled)

27. (canceled)

28. (canceled)
